(19) United States
(12) Patent Application Publication
(10) Pub. No.: US 2007/0089336 A1
(43) Pub. Date: Apr. 26, 2007

(54) Computer device with display-based option card system

(76) Inventor: Brian D. Ryder, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/250,254

(22) Filed: Oct. 14, 2005

(51) Int. Cl. G09F 11/00

(52) U.S. Cl. 40/491

(57) ABSTRACT

A computer device comprises a housing for supporting a display element, the housing having at least one opening configured to receive at least a portion of an option card therethrough.

### BACKGROUND OF THE INVENTION

Notebook, tablet and other types of computers are becoming increasingly flexible at least in terms of wireless communication capabilities, data interface capabilities and other functions. However, such computer devices are also being designed smaller and/or more compact (e.g., having slimmer dimensions and/or profiles). One method for providing additional functionality to such computer devices is attaching an option onto a rear side of a display member of the computer device (e.g., removing a portion of a rear cover of the display member and attaching a wireless communications package, for example, in replacement thereof to the rear of the display member). However, attaching an option onto a rear side of a display member of the computer device increases the thickness of the display member, thereby also undesirably increasing the overall thickness of the computer device.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of a computer device having a display-based option card system in accordance with the present invention;

FIG. 2 is a diagram illustrating a broken-away portion of the computer device of FIG. 1;

FIG. 3 is a section view of the computer device of FIG. 1 taken along the line 3-3 of FIG. 1; and

FIG. 4 is a section view illustrating another embodiment of a computer device having a display-based option card system in accordance with the present invention.

### DETAILED DESCRIPTION OF THE DRAWINGS

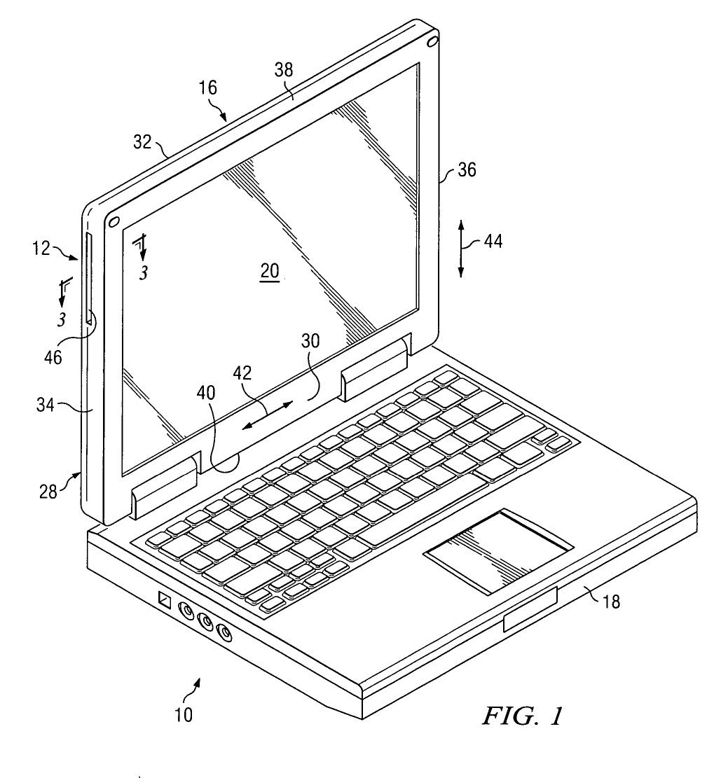

The preferred embodiments of the present invention and the advantages thereof are best understood by referring to FIGS. 1-4 of the drawings, like numerals being used for like and corresponding parts of the various drawings.

FIG. 1 is a diagram illustrating an embodiment of a computer device 10 having a display-based option card system 12 in accordance with the present invention. In the embodiment illustrated in FIG. 1, computer device 10 comprises a portable laptop or notebook computer having a display member 16 rotatably coupled to a base member 18. However, it should be understood that computer device 10 may comprise other types of computing devices such as, but not limited to, a tablet computer, personal digital assistant, a monitor and/or other type of display device (e.g., a liquid crystal display (LCD)), a desktop computer system or other type of portable or non-portable device generally having a display element 20 for displaying images and/or other types of graphical content to a user.

In the embodiment illustrated in FIG. 1, display member 16 comprises a housing 28 for supporting display element 20. In this embodiment, housing 28 comprises a front housing portion 30, a rear housing portion 32 disposed opposite front housing portion 30, and side housing portions 34, 36, 38, and 40. As illustrated in FIG. 1, front housing portion 30 of housing 28 generally coincides with a viewable portion of display element 20, and rear housing portion 32 generally coincides with a back or rear cover of display member 16. In the embodiment illustrated in FIG. 1, side housing portions 34 and 36 generally comprise vertical sides of display member 16 corresponding to a vertical dimension of display member 16 indicated generally by 44, and side housing portions 38 and 40 of display member 16 generally comprise horizontal sides of display member 16 corresponding to a horizontal dimension of display member 16 indicated generally by 42. However, it should be understood that side housing portions 34, 36, 38 and 40 may be otherwise identified and/or associated with different dimensions or portions of display member 16 (e.g., as in a tablet computer where the viewing orientation may be otherwise changed and/or rotated).

In the embodiment illustrated in FIG. 1, system 12 comprises an opening 46 formed in housing 28 and configured to receive an option card therein (e.g., any type of electronic card such as, but not limited to, a wireless interface card, universal serial bus (USB) interface card, memory card, etc.). In the embodiment illustrated in FIG. 1, opening 46 is disposed in vertical side housing portion 34 of housing 28. However, it should be understood that opening 46 may be otherwise located on housing 28 (e.g., on vertical side housing portion 36 and/or horizontal side housing portions 38 and/or 40). Further, in the embodiment illustrated in FIG. 1, a single opening 46 is illustrated as being disposed in housing 28. However, it should be understood that display member 16 may be configured having multiple openings 46, each configured for receiving an option card therein.

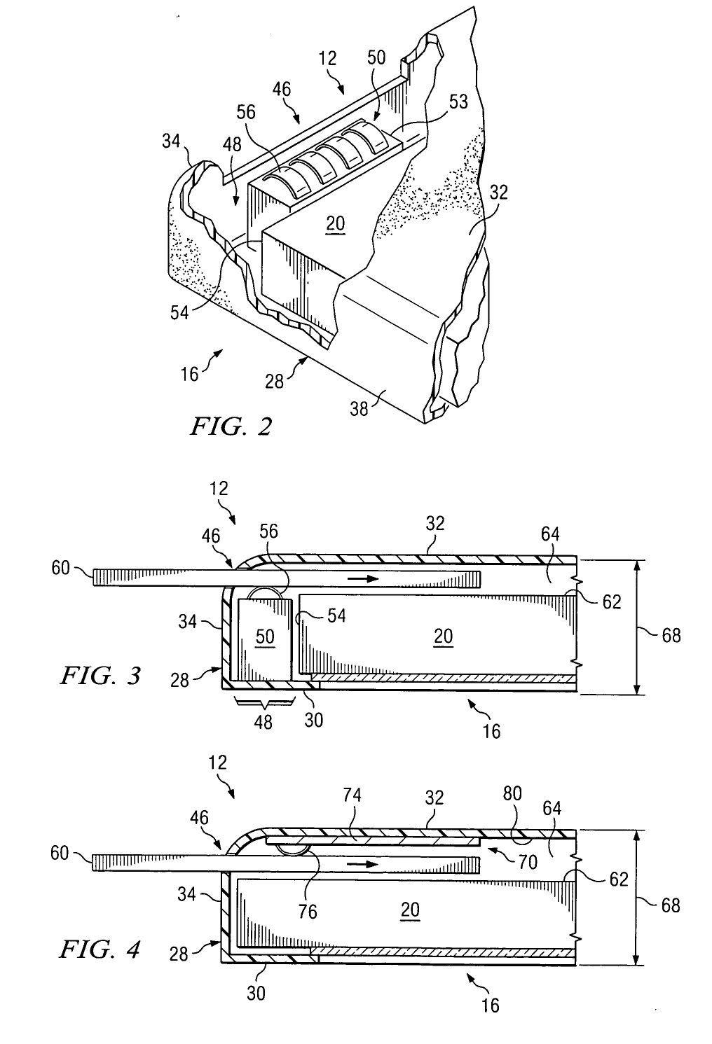

FIG. 2 is a diagram illustrating a broken-away portion of display member 16 illustrated in FIG. 1. In the embodiment illustrated in FIG. 2, housing 28 is configured having a gap 48 disposed between display element 20 and one of side housing portions 34, 36, 38 and/or 40 and having a connector element 50 of system 12 disposed at least partially therein. In the embodiment illustrated in FIG. 2, gap 48 is disposed between vertical side housing portion 34 of housing 28 and a vertical side portion 54 of display element 20. However, it should be understood that gap 48 may be otherwise located corresponding to each of side housing portions 36, 38 and/or 40 relative to display element 20. Preferably, gap 48 is predetermined and/or pre-sized to accommodate at least a portion of connector element 50 therein. In the embodiment illustrated in FIG. 2, connector element 50 comprises a spring-based contact connector element 53 having biased contact elements 56 for communicatively engaging an option card inserted through opening 46 to an internal area of housing 28 disposed rearwardly of display element 20. However, it should be understood that other types of connector elements 50 may be used.

FIG. 3 is a diagram illustrating a section view of display member 16 of FIG. 1 taken along the line 3-3 of FIG. 1. As illustrated in FIG. 3, connector element 50 is preferably disposed within gap 48 such that at least a portion of connector element 50 is positioned between vertical side housing portion 34 of housing 28 and vertical side portion 54 of display element 20. In the embodiment illustrated in FIG. 3, contacts 56 of connector element 50 are rearwardly oriented (i.e., disposed facing rear portion 32 of housing 28) to communicatively engage an option card 60 disposed at least partially between rear portion 32 of housing 28 and a rear side 62 of display device 20 when inserted through opening 46 and into housing 28. Thus, in operation, option card 60 is inserted through opening 46 to an internal area 64 of display member 28 between rear side 62 of display element 20 and rear housing portion 32 of housing 28 to communicatively engage connector element 50. In operation, connector element 50 is communicatively coupled to associated circuitry within computer device 10 (e.g., in display member 16 and/or base member 18) corresponding to a respective function associated with either connector 50 and/or the particular option card 60. As illustrated in FIG. 3, disposing at least a portion of connector element 50 between side portion 54 of display element 20 and side portion 34 of housing 28 reduces the thickness (e.g., as indicated generally by 68) of display member 16.

FIG. 4 is a section view illustrating another embodiment of a computer device having a display-based option card system in accordance with the present invention. In the embodiment illustrated in FIG. 4, a connector element 70 is coupled to an internal side 80 of rear housing portion 32. For example, in the embodiment illustrated in FIG. 4, connector element 70 comprises a spring-based contact connector element 74 having biased contact elements 76 for communicatively engaging option card 60 inserted through opening 46 to internal area 64 of housing 28. In the embodiment illustrated in FIG. 4, contact elements 76 are forwardly oriented (i.e., facing rear side 62 of display element 20) to communicatively engage an option card 60 disposed at least partially between rear portion 32 of housing 28 and a rear side 62 of display device 20 when inserted through opening 46 and into housing 28. Thus, in operation, option card 60 is inserted through opening 46 to an internal area 64 of display member 28 between rear side 62 of display element 20 and rear housing portion 32 of housing 28 to communicatively engage connector element 50. In operation, connector element 70 is communicatively coupled to associated circuitry within computer device 10 (e.g., in display member 16 and/or base member 18) corresponding to a respective function associated with either connector 70 and/or the particular option card 60.

Thus, embodiments of the present invention enable an option card system 12 to be incorporated into a display member 16 of a computer device 10 while maintaining a low profile and/or component thickness of such display member 16. For example, embodiments of the present invention provide an opening 46 in display member 16 for receiving an option card therethrough to engage corresponding circuitry disposed within display member 16 (e.g., connector 50/70 and/or other corresponding electronic components). Embodiments of the present invention may be manufactured having a number of different connector element positions within display member 16 for engaging the option card, thereby facilitating insertion of the option card into display member 16 at a variety of corresponding locations.

What is claimed is:

1. A computer device, comprising:
a housing for supporting a display element, the housing having at least one opening configured to receive at least a portion of an option card therethrough.

2. The computer device of claim 1, further comprising a connector element disposed within the housing for communicatively engaging the option card.

3. The computer device of claim 1, further comprising a connector element disposed at least partially between a side portion of the display element and a side portion of the housing.

4. The computer device of claim 1, further comprising a connector element disposed within the housing rearwardly of the display element for communicatively engaging the option card.

5. The computer device of claim 1, further comprising a connector element disposed within the housing, the option card insertable between the connector element and a rear side of the display element.

6. The computer device of claim 1, wherein the at least one opening is disposed to receive the option card between a rear side of the display element and a rear side of the housing.

7. The computer device of claim 1, wherein the connector element comprises at least one contact element disposed facing a rear side of the housing.

8. The computer device of claim 1, wherein the housing comprises a display member housing of a portable computer device.

9. The computer device of claim 1, wherein the connector element comprises at least one contact element disposed facing a rear side of the display element.

10. A computer device, comprising:
means for displaying an image;
means for supporting the displaying means, the supporting means having at least one opening formed therein for receiving at least a portion of an option card therethrough.

11. The computer device of claim 10, further comprising means, disposed within the supporting means, for communicatively engaging the option card.

12. The computer device of claim 10, further comprising means, disposed within the supporting means, for communicatively engaging the option card when the option card is disposed at least partially between the displaying means and a rear side of the supporting means.

13. The computer device of claim 10, further comprising means, disposed at least partially between a side portion of the supporting means and a side portion of the display means, for communicatively engaging the option card.

14. A method for manufacturing a computer device, comprising:
providing a housing adapted to support a display element, the housing having at least one opening configured to receive at least a portion of an option card therethrough.

15. The method of claim 14, further comprising providing a connector element within the housing for communicatively engaging the option card.

16. The method of claim 14, further comprising providing a connector element in the housing having at least a portion thereof disposed between a side portion of the display element and a side portion of the housing.

17. The method of claim 14, further comprising providing a connector element in the housing having at least a portion thereof disposed between a rear side the display element and a rear side of the housing.

18. The method of claim 14, further comprising configuring the housing to receive the option card between a rear side of the display element and a rear side of the housing.

19. The method of claim 14, further comprising providing a connector element in the housing for engaging the option card, the connector element having at least one contact element facing a rear side of the housing.

20. The method of claim 14, further comprising providing a connector element in the housing for engaging the option card, the connector element having at least one contact element facing a rear side of the display member.

21. The method of claim 12, further comprising rotatably coupling the housing to a housing of a base member of a portable computer device.
